(19) United States
(12) Patent Application Publication
(10) Pub. No.: US 2006/0206392 A1
(43) Pub. Date: Sep. 14, 2006

(54) Computer implemented retail merchandise procurement apparatus and method

(75) Inventors: James P. Rice JR., Akron, OH (US); Charles C. Bowlus, Sarasota, FL (US)

Correspondence Address: Mark S. Svat, Esq.;Fay, Sharpe, Fagan, Minnich & McKee, LLP, Seventh Floor, 1100 Superior Avenue, Cleveland, OH, 44114-2579, US

(73) Assignee: Efficient Collaborative Retail Marketing Company

(21) Appl. No.: 11/360,089

(22) Filed: Feb. 22, 2006

Related U.S. Application Data
(60) Provisional application No. 60/655,546, filed on Feb. 23, 2005.

(51) Int. Cl. G06Q 30/00

(52) U.S. Cl. 705/26

(57) ABSTRACT

In an apparatus for identifying one or more retail merchandise suppliers, a web-based scorecard (12) is configured to acquire supplier-related information of interest to a retailer (16). A database (42) communicates with the web-based scorecard to store the acquired supplier-related information sorted at least by responding supplier (30, 32). An emailer (26) is configured to send to at least thirty businesses email content (20) including at least: a business opportunity description (21); a URL address (14) pointing to the web based scorecard; and instructions (22) to respond via the web based scorecard in order to be considered for the business opportunity. A processor (44, 52) communicates with the database and is configured to select or facilitate selecting between one and eight of said at least thirty businesses as candidate suppliers (50) based on the corresponding supplier-related information.

This application claims the benefit of U.S. Provisional Application No. 60/655,546 filed Feb. 23, 2005. U.S. Provisional Application No. 60/655,546 is incorporated herein by reference in its entirety.

### BACKGROUND

The following relates to the procurement arts. It especially relates to apparatuses and methods for locating and qualifying suppliers providing merchandise for mass-market retailing, and is described with particular reference thereto. However, the following will also find application in conjunction with other like applications.

Modern retail is typically driven by mass-market retail chains that operate dozens, hundreds, thousands or more stores located regionally, nationally, or globally. Such retailers are continually looking for suppliers to provide substantial quantities of merchandise for retail. Each retailer applies certain standards, preferences, and other considerations in selecting suppliers. For example, some retailers are looking for suppliers who can provide just-in-time shipping, so as to reduce warehousing costs at the retail end. Some retailers are concerned about public image, and are looking for suppliers who practice commendable business practices. Some retailers specialize in low-cost or bargain merchandise, and are looking for efficient, low cost suppliers. Most retailers want reliable suppliers who will consistently meet delivery deadlines and will consistently deliver the quantity and type of goods promised.

Regional, national, and global retailers advantageously search regionally, nationally, or globally to find suitable merchandise suppliers. However, actually searching for suppliers in a geographical area that is unfamiliar to the retailer and its usual agents, or in a geographical area that is politically or economically unstable geographically remote, or so forth, is surprisingly difficult. Procurement of goods from remote, unfamiliar, or unstable areas can be risky. While many suppliers will readily agree to a lucrative large-volume supply contract, some such suppliers may not have adequate manufacturing capacity to meet the high-volume needs of a mass-market retailer, or may employ manufacturing practices that are unacceptable to the retailer, or may have other latent inadequacies. Given the logistical difficulties of merchandise procurement, it is important that the retailer locate and develop business relationships with reputable and capable suppliers who meet the retailer's quality, cost, reliability, or other requirements or preferences.

Heretofore, the usual approach for locating new suppliers in an unfamiliar region has been through the hiring of local human agents in the targeted region or country who have local contacts and familiarity with the locale. These local agents are often themselves unknown quantities as far as the retailer is concerned. Nonetheless, the retailer relies on such local agents to locate and recommend potential suppliers. In a typical approach, the local agent uses local contacts, such as local industry associations, local government agencies, word-of-mouth, or other local resources, to initially identify a substantial number of candidate suppliers (for example, dozens of candidate suppliers). Local inspectors or auditors are then sub-contracted by the local agent to perform the on-site inspections or audits of each candidate supplier's manufacturing facilities, transportation network, employment practices, and so forth. Based on these on-site inspections and audits, the local agent recommends one, or a very few, suppliers to the retailer, who then attempts to establish a business relationship with the recommended suppliers, typically again using the local agent as a go-between to facilitate initial contact.

This usual approach has severe drawbacks. For example, it is predicated upon the integrity of the hired local agents. In practice, it is not unheard of for such agents to recommend suppliers for reasons other than the best interests of the retailer. Moreover, the number of local agents and sub-agents involved can be substantial. A typical evaluation of candidate suppliers may involve dozens or hundreds of local agents, inspectors, auditors, and so forth, each of whom increases cost to the retailer and presents a potential source of corruption or miscommunication. The number of candidate suppliers to be evaluated can be substantial, and each evaluation requires costly on-site inspection or auditing. A candidate supplier will rarely refuse to entertain a potentially lucrative business opportunity, and so the inadequacy of a supplier may not be discovered until the supplier's manufacturing plant or other facilities are inspected or audited in-person by local agents of the retailer. Still further, the accuracy of these evaluations is strongly dependent upon clear and effective communication between the retailer and the local agents, between the local agents and their sub-agents, and between the agents and sub-agents and the candidate suppliers. The repeated handoff of information from the retailer to the local agents and sub-agents to the supplier, then back to the local agents and sub-agents and ultimately back to the retailer, provides many opportunities for miscommunication.

### BRIEF SUMMARY

According to one aspect, a method is disclosed for identifying one or more retail merchandise suppliers. A web-based scorecard is generated that is configured to elicit supplier-related information of interest to a retailer. Email content is constructed including at least: (i) a business opportunity description; (ii) a URL address pointing to the web based scorecard; and (iii) instructions to respond via the web based scorecard in order to be considered for the business opportunity. The email content is emailed to at least thirty businesses. Responses are received from at least some of the at least thirty businesses via the web-based scorecard. Each said response includes completing at least a portion of the web based scorecard. Between one and eight of said at least thirty businesses are identified as candidate suppliers based on responses to the web-based scorecard. Further contact is performed between the retailer and suppliers limited to the identified candidate suppliers.

According to another aspect, an apparatus is disclosed for identifying one or more retail merchandise suppliers. A web-based scorecard is configured to acquire supplier-related information of interest to a retailer from potential suppliers. A database communicates with the web-based scorecard to store the acquired supplier-related information sorted at least by responding potential supplier. An emailer is configured to send to a plurality of potential suppliers email content including at least: a business opportunity description; a URL address pointing to the web based scorecard; and instructions to respond via the web based scorecard in order to be considered for the business opportunity. A processor communicates with the database and is configured to select one or more of said plurality of potential suppliers based on the corresponding supplier-related information.

According to another aspect, a computer-implemented method is disclosed for identifying one or more retail merchandise suppliers. A website is constructed that hosts a web-based scorecard configured to acquire supplier related information of interest to a retailer from potential suppliers. The web-based scorecard includes questions to be answered by potential suppliers and score assignments for said questions. An email is sent to a plurality of potential suppliers. The email has content including at least a business opportunity description, a URL address pointing to the web-based scorecard, identifying information that identifies the potential supplier to whom the email is sent, and instructions for the potential supplier to respond via the web-based scorecard in order to be considered for the business opportunity. Responses are received from at least some of the potential suppliers via the website hosting the web-based scorecard. The responses include the identifying information that identifies the responding potential supplier and responses to the questions of the web based scorecard provided by the responding potential supplier. The responses and scores derived from said responses are stored in a database communicating with the website hosting the web-based scorecard. The stored responses and scores are sorted at least by potential supplier based on the identifying information. The stored responses and scores are processed to select at least one responding potential supplier as the retail merchandise supplier.

### BRIEF DESCRIPTION OF THE DRAWINGS

FIG. 1 diagrammatically shows an apparatus for performing an automated Internet-based first stage of a two-stage supplier selection process.

FIG. 2 diagrammatically shows a process for generating a scorecard.

FIG. 3 diagrammatically shows a process for generating a scorecard having different categories.

FIG. 4 diagrammatically shows a process for generating a scorecard using a scorecard template.

FIG. 5 shows a sample portion of a web-based scorecard.

FIG. 6 shows sample email content sent to potential suppliers.

FIG. 7 shows a sample analysis display comparing the answer of each responding supplier to the question: “List your top customers”.

FIG. 8 diagrammatically shows a process performed by the veracity analyzer of FIG. 1.

FIG. 9 diagrammatically shows a first embodiment of the second stage of a two-stage supplier selection process.

FIG. 10 diagrammatically shows a second embodiment of the second stage of a two-stage supplier selection process.

### DETAILED DESCRIPTION OF PREFERRED EMBODIMENTS

The present inventors have extensive experience in the field of retail merchandise procurement facilitation, and have recognized that a principal difficulty with existing techniques resides in the extensive use of local human agents during the supplier candidates identification phase of the search process. The extensive reliance on local agents invites corruption, miscommunication, wasted effort, and unnecessary cost. The local agent is interested in locating as many candidate suppliers as possible, but some of these candidate suppliers may have limited interest or may be unqualified to perform the work. Extensive and costly on-site inspection and auditing is then performed to weed out these unsatisfactory candidate suppliers.

On the other hand, the present inventors have recognized that while on-site inspection and auditing enables the retailer to contract with confidence with the chosen one or few suppliers, such on-site inspections and audits are difficult to perform using non-local agents who operate in a knowledge vacuum and are unlikely to be familiar with locale-specific issues and concerns that should be addressed, such as local weather, local transportation capabilities and limitations, local government regulatory concerns, and so forth.

Accordingly, a process is set forth herein, which reduces or eliminates the use of local human agents. Contact is made with local businesses in an automated electronic fashion via the Internet. Contacted businesses must actively respond to the retailer with substantial information about their manufacturing capabilities, employment practices, or other business aspects of interest to the retailer. This active response requirement ensures that there is substantial interest on the part of candidate suppliers. The candidate suppliers' responses take the form of answers to a scorecard containing questions pertinent to the qualifications of the candidate supplier. The scorecard includes questions posed to elicit answers that can be used in scoring or ranking potential suppliers. In some embodiments, the scorecard is configured to enable a veracity analysis at the retailer's end to determine the truthfulness of the provided answers. Moreover, since the local businesses respond directly to the scorecard, rather than through a local agent intermediary, the likelihood of miscommunication is substantially reduced. These Internet-based contacts are inexpensive compared with the hiring of local agents, and enable the retailer to rapidly eliminate unsatisfactory candidate suppliers based on the answers provided on the scorecard.

On the basis of the scorecard responses, the retailer can readily identify one or a very few candidate suppliers who appear to be satisfactory. At this point, local human agents are optionally hired to inspect or audit this small number of candidate suppliers. Because the number of candidate suppliers has been vastly reduced before the hiring of local agents, it is possible to perform optional on-site inspection or auditing using very few local agents or sub-agents. For example, a single local inspector may be sufficient to audit the one, two, three, or so candidate suppliers who have passed the initial scorecard-based evaluation. Moreover, if a veracity analysis is incorporated into the scorecard, the retailer may have enough confidence in the candidate suppliers who have passed the initial scorecard-based evaluation to employ outside agents to perform the inspections or audits, or to omit the on-site inspections or audits entirely and immediately initiate supply contract negotiations with the candidate supplier or suppliers.

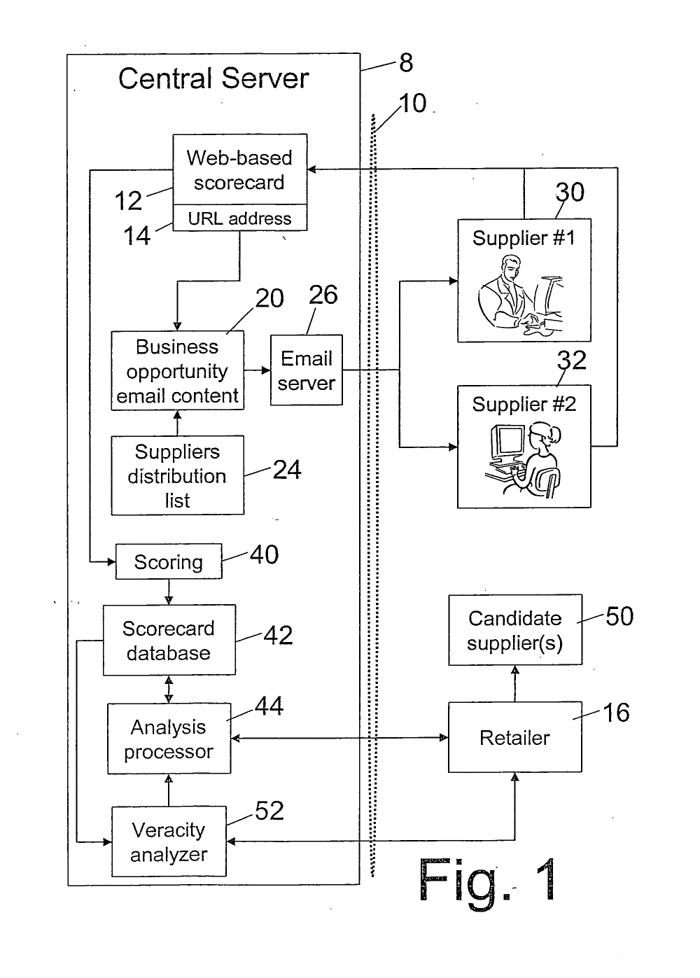

With reference to FIG. 1, a central server 8 is configured to communicate with the Internet 10. The central server 8 hosts a web-based scorecard 12 that is externally accessible via the Internet 10 using a web browser. The web-based scorecard has an associated uniform resource locator (URL) address. 14. The web-based scorecard 12 is configured to elicit supplier-related information of interest to a retailer 16 in selecting suitable retail merchandise suppliers. Such supplier-related information may include, for example, information about manufacturing capacity, employment policies, warehousing capacity, manufacturing turnaround time, current customers, and so forth.

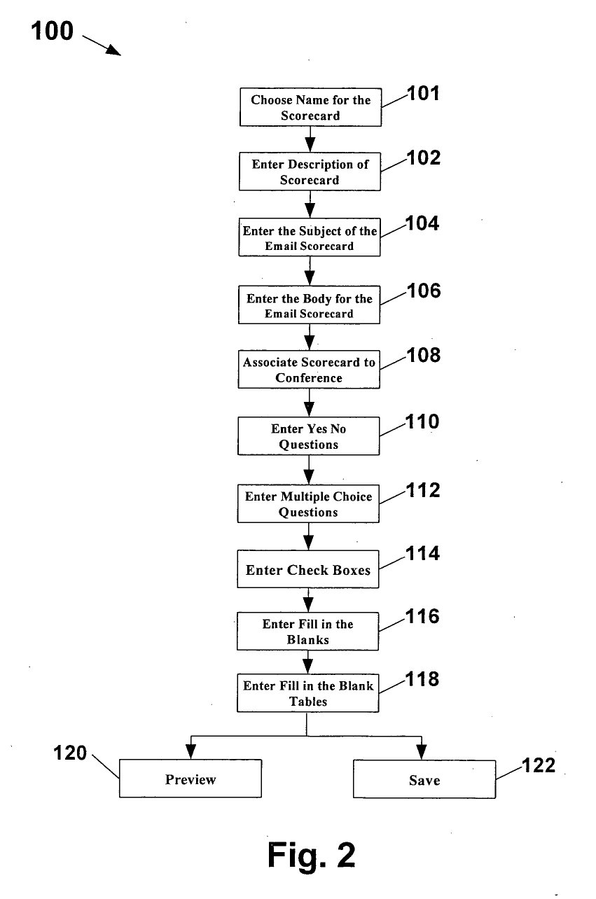

FIG. 2 shows a suitable process 100 for creating the scorecard 12. A name is chosen 101 for the scorecard, and a description of the scorecard is entered 102. To facilitate emailing of the scorecard, an email subject line and body text are optionally entered 104, 106. In some embodiments, the recipient potential suppliers are identified at a conference, and so the scorecard is associated with a distribution list for the conference 108. In other embodiments, a list of recipient potential suppliers is provided by a local trade organization or so forth. The content of the scorecard is then constructed. The content typically takes the form of questions, such as questions that can be answered “yes” or “no” 110, multiple-choice questions 112, questions that can be answered by selecting a check box 114, questions having free-form text entry responses (i.e., “fill-in-the blank” questions) 116, “fill-in-the-blank” tables 118, or so forth. Preferably, the scorecard is generated using a webpage composer or other software that provides a what-you-see-is-what-you-get (WYSIWYG) view or a preview 120 of the actual web-based scorecard. The scorecard can be saved 122 intermittently during its creation (to avoid losing work) and when completed.

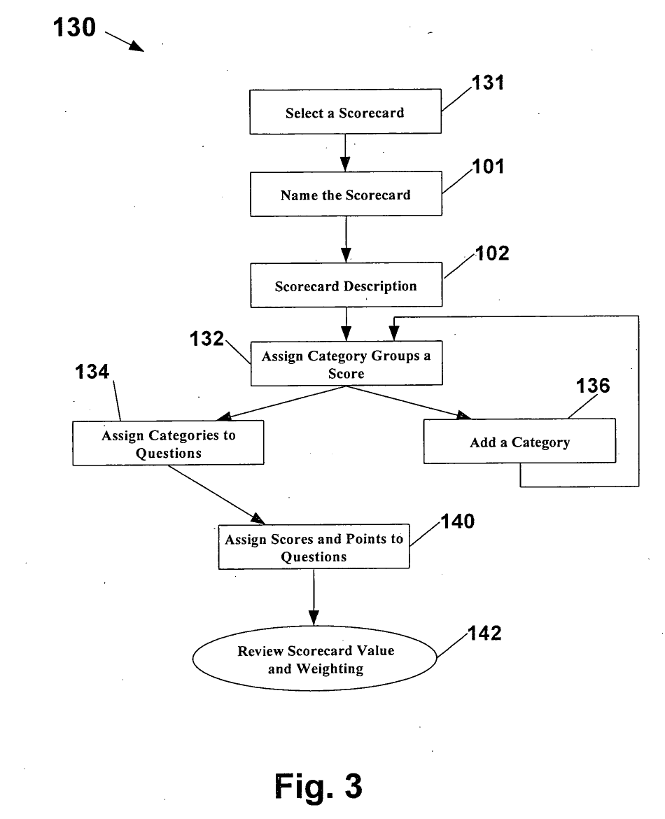

FIG. 3 shows a process 130 for assigning scores to the scorecard. Although the scorecard may have only a single overall score, in some embodiments the scores are grouped by category so as to enable separate scoring of different categories. For example, some suitable categories may include: employment practices; manufacturing capacity; manufacturing throughput efficiency; product cost; supplier history or stability; and so forth. A given potential supplier may score higher in some categories than in other categories, e.g. a given potential supplier may score high in manufacturing capacity but low in product cost. A scorecard is selected 130 or generated in accordance with the method 100 of FIG. 2. The scorecard is named 101 and a description is entered 102. Category groups are assigned 132, and questions are assigned 134 to various categories. As the process continues, it is advantageous to provide for the addition 136 of new categories, for example if it becomes apparent that separate scoring of manufacturing quality or so forth is desirable. Scores and points are assigned to various questions 140, and the scorecard value and weighting is reviewed 142 to ensure that the various categories are given their desired weights. For example, if product cost is especially important to the retailer 16, then those questions in the product cost category should be given relatively high weights.

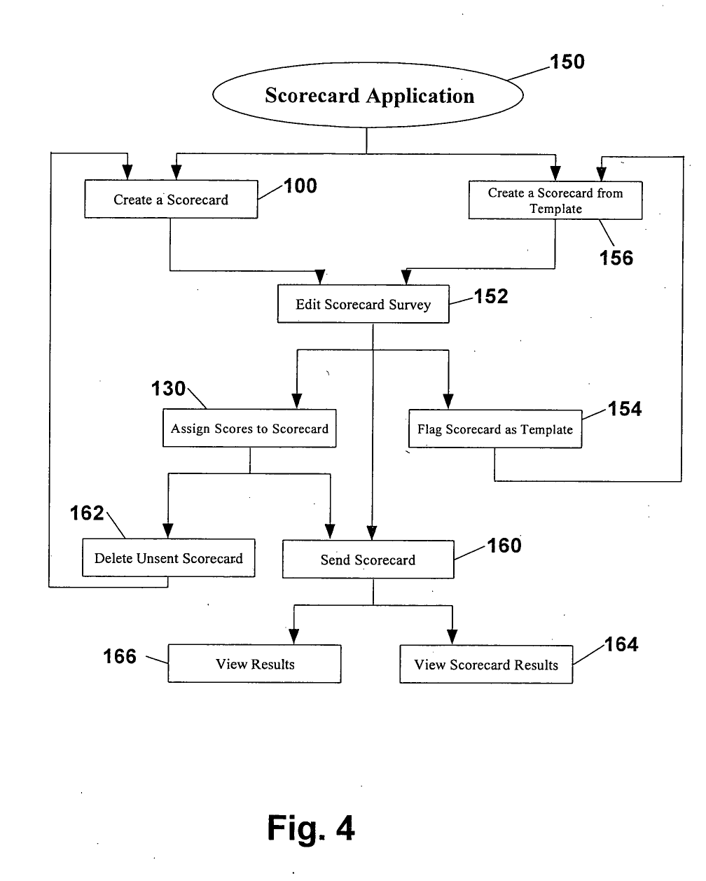

With reference to FIG. 4, in some embodiments scorecard templates may be maintained and used to streamline the scorecard construction process. In such a scorecard application 150, a scorecard is created in accordance with the process 100 of FIG. 2, is optionally edited 152, and is flagged 154 for storage as a template. Thereafter, a new scorecard can be created by retrieving 156 the scorecard template and editing 152 the scorecard template to customize it for the purposes of the specific retailer 16. The scorecard optionally has scores assigned to questions and optionally categories in accordance with the scores assignment process 130 of FIG. 3, and is sent 160 to potential suppliers. On the other hand, if the scorecard is found to be unsatisfactory, it is optionally deleted 162 without sending. The answers to the scorecard provided by potential customers via the web-based scorecard can be viewed 164, sorted by company 166, or so forth.

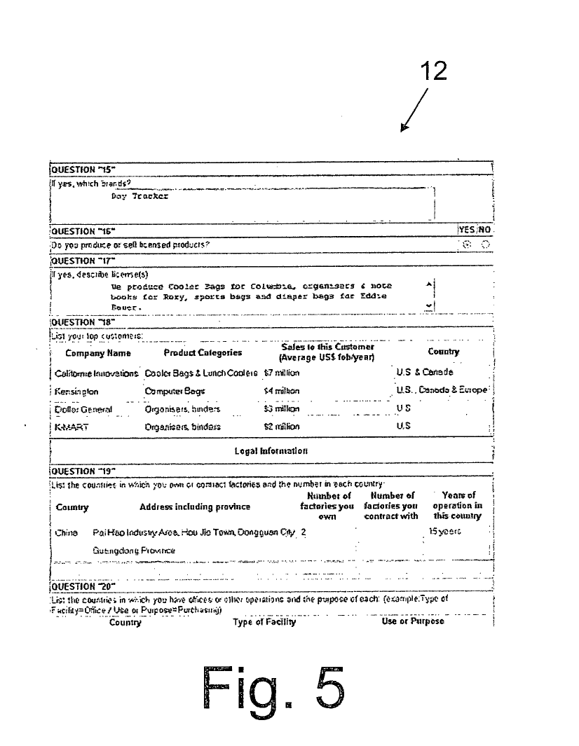

FIG. 5 shows a portion of a sample web-based scorecard 12 including questions (already filled out by a potential supplier in the view of FIG. 5) related to a potential supplier's current customers and current manufacturing activities. While the central server 8 is illustrated as a single unitary component, it is to be appreciated that the central server may be a distributed server, for example including two or more computers at different physical locations. The central server 8 is “central” in that it serves as a single logical point for hosting the web-based scorecard 12 and for collecting scorecard responses.

It is desired for the web-based scorecard to be completed by potential suppliers who may be willing and able to supply retail merchandise to the retailer 16. The questions of the web-based scorecard 12 are chosen to elicit information of interest to the particular retailer who is looking for one or more suppliers. Thus, the questions of the web-based scorecard 12 will depend upon the supplier characteristics of interest to the retailer 16. The retailer 16 constructs (or has a suitable web designer construct) the web-based scorecard 12 to pose questions pertaining to the type or types of information which the retailer 16 wants to elicit.

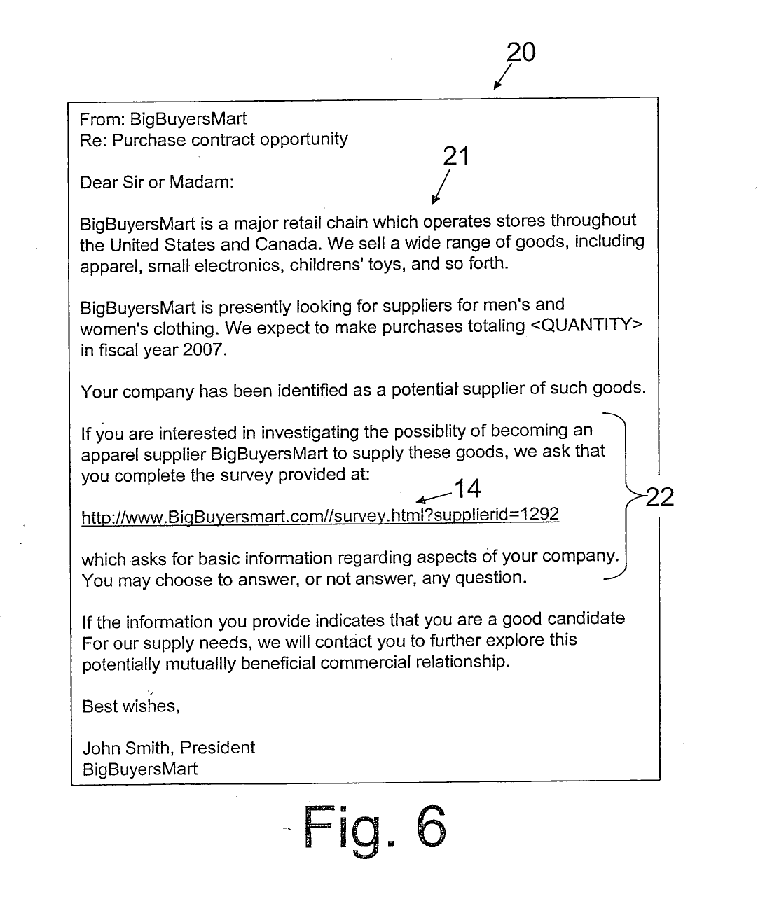

With continuing reference to FIG. 1 and with further reference to FIG. 6, once the web-based scorecard 12 is constructed (said construction including for example the process 100 of FIG. 2, optional scores assignments by the process 130 of FIG. 3, and configuring the central server 8 such that the web-based scorecard 12 is externally accessible via the URL address 14), suitable email content 20 is constructed to set forth the potential business opportunity to potential suppliers, and to invite such suppliers to respond via the web-based scorecard 12. FIG. 6 illustrates sample email content 20. While the email content 20 can be different from that of FIG. 6, it typically includes at least: (i) a description of the business opportunity 21 (this content is textual in FIG. 6, but embedded JPEG images, audio, or so forth are also contemplated); (ii) the URL address 14 pointing to the web-based scorecard 12; and (iii) instructions 22 for the potential supplier to respond via the web-based scorecard 12 in order to be considered for the business opportunity (again, this content is textual in FIG. 6, but embedded JPEG images, audio, or so forth are also contemplated, and additionally it is to be appreciated that the business opportunity description and instruction portions can be interwoven or otherwise integrated as textual or otherwise-formatted content). In some cases, the suppliers will be substantially unknown to the retailer 16 and vice versa—accordingly, the business opportunity description 21 optionally includes a concise description of the retailer 16.

The email content 20 is emailed to email addresses of potential suppliers listed on a suppliers distribution list 24 by an email server 26 of the central server 8. In FIG. 1, two example suppliers 30, 32 are illustrated; however, typically the number of potential suppliers to which the email content 20 is distributed is thirty or more, and may be as high as a hundred or more. It will be appreciated that the suppliers 30, 32 are typically located remote from the central server 8, and in typical situations may be located in a different state, region, or country than that hosting the central server 8. The suppliers distribution list 24 may be obtained from various sources, such as an industry association operating in the state, region, or country of interest, a government organization, a state, regional, or national chamber of commerce, a telephone directory (printed or Internet-based), or so forth.

Each supplier 30, 32 then has a decision to make—Whether or not to respond to the received email by clicking on the URL address 14 and completing the web-based scorecard 12. In some cases, the supplier may be uninterested, either because it realizes it cannot provide the retail merchandise in sufficient quantities, or because it lacks confidence to engage in substantial export sales, or so forth. In these cases, the supplier will not respond, and so that lack of response is suitably taken by the retailer 16 as evidence of lack of interest causing the retailer 16 to exclude the non-responding suppliers as candidate suppliers. Some level of non-response is typically to be expected since the suppliers distribution list 24 was generated from indirect information and may include businesses in other manufacturing areas or businesses that are otherwise unqualified to accept the supply opportunity.

However, it is anticipated that many suppliers will be interested in pursuing the business opportunity described in the email content 20, and will therefore click on the URL address 14 to access the web-based scorecard 12 (or, alternatively, will manually type the URL address into the URL address input of a web browser or will otherwise act to access the web-based scorecard 20 via the URL address 14). In FIG. 1, both suppliers 30, 32 are illustrated as responding to the email by accessing the web-based scorecard 12. This response is easy and rapid for the supplier, which can respond via the Internet 10 without any need for traveling or even making a telephone call. (Optionally, however, the email content 20 includes a telephone number or other authenticating mechanism which the supplier can optionally follow up on prior to going to the URL address 14; such an authenticating mechanism can be useful in case the supplier is concerned that the email contains a virus or other malicious computer code).

The web-based scorecard 12 can include various types of user input dialog features, such as free-form text entry spaces, drop-down list selectors, checkboxes, or so forth. Each supplier who responds to the email and completes (or partially completes) the web-based scorecard 12 generates supplier-related information corresponding to that supplier. The supplier-related information provided by each responding supplier is associated with that supplier. For example, in FIG. 6, the URL address:
http://www.BigBuyersmart.com//survey.html?supplierid=1292
   includes the suffix “?supplierid=1292” which is a query string indicating the supplier identification number. In this approach, the URL address included in the email content includes a different, unique supplier identification number for each supplier. Thus, for example, the supplier 30 may be sent the email of FIG. 6 thus assigning supplier 30 the identification number 1292, while the supplier 32 may be sent the identical email except including the URL address:
http://www.BigBuyersmart.com//survey.html?supplierid=1293
   which assigns the supplier 32 with identification number 1293. In other embodiments, the associating of supplier-related information with supplier can employ a user-inputted password or other indexing mechanism.

When a supplier completes (or partially completes) the web-based scorecard 12, the acquired supplier-related information corresponding to that supplier is passed to a scoring processor 40 which computes one or more scores based on the supplier-related information. In some embodiments, the questions of the scorecard are grouped into different categories, and a score is computed for each category. For example, a scorecard may include categories such as: “manufacturing facilities”, “employment practices”, “Supplier history”, or so forth, and the questions in each category are used to compute a score for that category. The supplier-related information along with the assigned scores are stored in a scorecard database 42, sorted at least by responding supplier (for example, sorted by supplier identification number in the case of the embodiment of FIG. 6). Optionally, the supplier-related information may be secondarily sorted by category or other sorting basis.

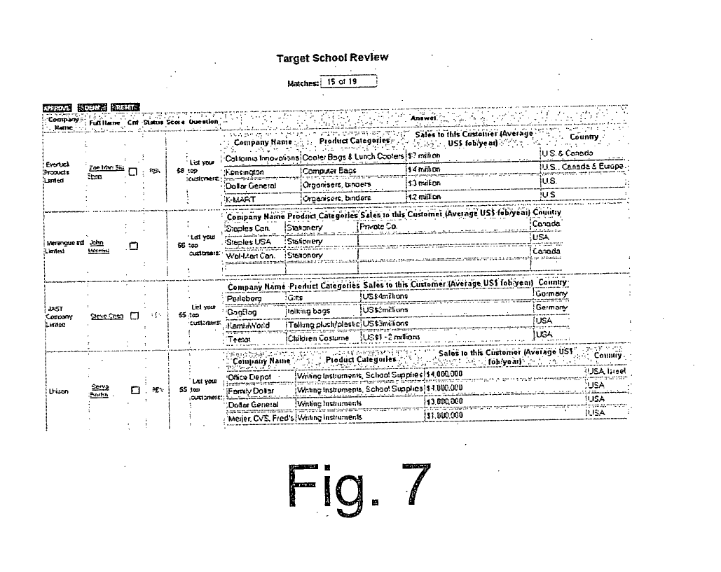

With continuing reference to FIG. 1 and with further reference to FIG. 7, the retailer 16 can review the supplier-related information stored in the scorecard database 42 via the Internet 10, as shown in FIG. 7. Additionally or alternatively, if the central server 8 is owned or controlled by the retailer 16, then the retailer 16 may be able to directly access the server 8 via a local area network or so forth. An analysis processor 44 is used to rank responding suppliers by score (either a global score or, for example, a category score associated with a category such as “manufacturing facilities”, “employment practices”, “Supplier history”, or so forth), compare answers of different suppliers to a particular question on a single screen, or so forth. Based on such analysis, the retailer 16 suitably selects one or a few candidate suppliers 50 for further consideration and/or contact. For example, FIG. 7 shows a sample analysis display in which the answer to the question “List your top customers” is shown for each responding supplier (listed in the leftmost column of FIG. 7). Such a comparison display is readily generated by the analysis processor 44 since it has access to the answer to this question provided by each responding supplier stored in the scorecard database 42. Typically, the number of candidate suppliers 50 selected by the retailer 16 is between one and eight, which is a number small enough to enable cost-effective intensive investigation such as on-site inspection or auditing. In some cases, the retailer 16 may select as few as a single candidate supplier for further consideration.

The supplier-related information is provided by the supplier. This self-interest aspect advantageously filters out those suppliers who receive the email but are uninterested, since such suppliers will not respond by filling out the web-based scorecard 12. However, the supplier's answers may be suspect, since the supplier may be willing to be less than fully truthful in answering the scorecard 12 in order to be more likely to be a selected candidate supplier. In some embodiments, this concern is addressed at least in part by constructing the scorecard 12 to include some self-consistency checks. In such embodiments, a veracity analyzer 52 determines a veracity measure for each responding supplier.

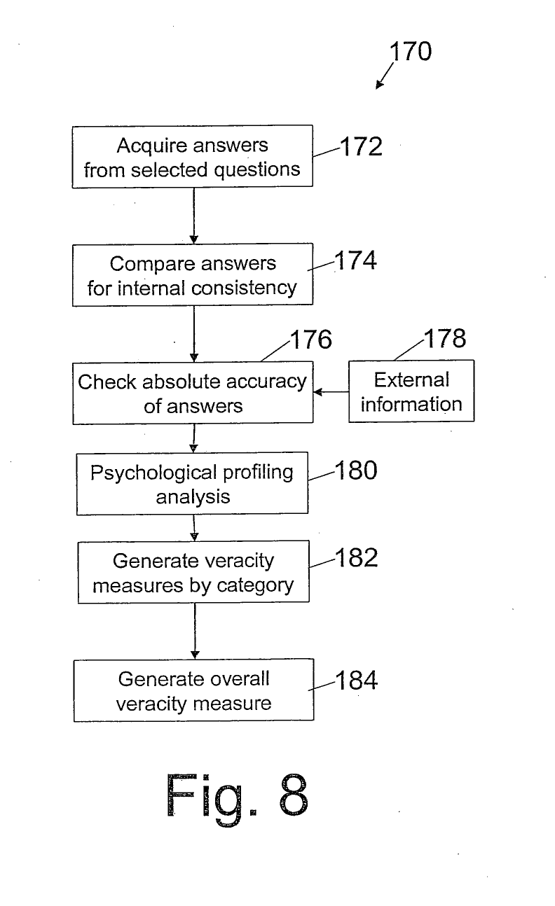

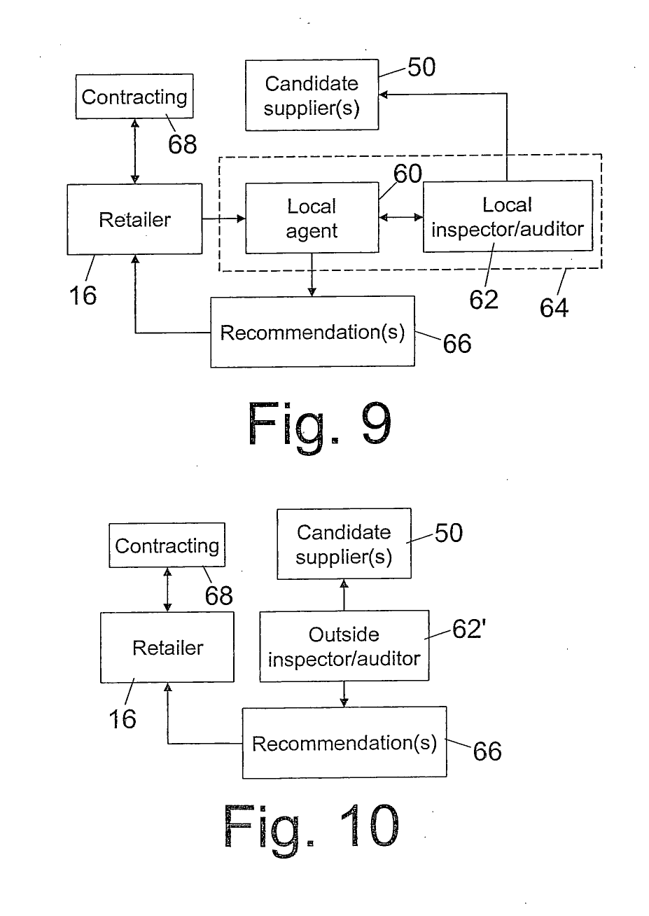

With reference to FIG. 8, a process 170 suitably performed by the veracity analyzer 52 is described. The answers are received 172 from the potential supplier whose veracity is to be analyzed. In one suitable veracity analysis technique, answers are compared for internal consistency 174 by comparison of different completed portions of the web-based scorecard. For example, a question on manufacturing capacity may ask: “How many manufacturing employees do you have?” while another question may ask: “How much do you pay annually in payroll taxes?” Comparison of the answers to these two questions may reveal that the supplier is employing child laborers, illegal immigrant laborers, or other undocumented laborers (since such undocumented laborers will not show up on the payroll tax creating a discrepancy between the two answers), or may show that the supplier is substantially underpaying its employees (again, creating a discrepancy between number of employees and the expected corresponding payroll taxes paid). Additionally or alternatively, in another veracity analysis technique the absolute accuracy of answers is checked 176 against external information 178. For example, if a question asks “Have you been cited by any government agency in any country for violations of environmental protection regulations?” and the potential supplier answers in the negative, this answer can be checked against records of government regulatory agencies in the country or countries in which the potential supplier operates. Additionally or alternatively, in another veracity analysis technique the scorecard includes questions configured by psychologists or other similar professionals to elicit answers indicative of veracity. For example, a question may ask “Has your company ever been late on a delivery?” with the expected answer being affirmative (since presumably any supplier who has been operating for a substantial period of time has at some point encountered unforeseen difficulties that cause a late delivery). If the potential supplier answers in the negative, this may be taken as a possible indication of lack of candor, thus negatively impacting the veracity score.

Based on veracity analyses such as the analyses 174, 176, 180, a veracity measure is constructed 182. In some embodiments, the veracity measure is by category in a manner similar to the scoring process 130 of FIG. 3. For example, independent veracity scores may be assigned respective to employment practices and manufacturing capabilities categories. Such category-independent veracity analysis can be useful since, for example, a company that engages in unsavory employment practices may be untruthful as to questions pertaining to employment practices, and yet be wholly truthful as to questions pertaining to manufacturing capacity. Additionally or alternatively, an overall veracity measure can be computed 184, for example by averaging the various category veracity scores or by scoring the veracity analyses without breaking the analyses down by categories.

Although the web-based scorecard 12 makes it relatively easy for suppliers 30, 32 to provide their corresponding supplier-related information, situations may arise in which the supplier cannot conveniently complete the entire scorecard in a single session. This may arise if the scorecard is long, or if it requires the input of more than one management employee of the supplier. For example, questions in the manufacturing capacity category may be best answered by a management employee in the engineering department, whereas questions in the employment practices category may be best answered by a management employee in the human resources department. To accommodate such situations, the web-based scorecard 12 is optionally configured to enable the supplier-related information to be provided in two or more sessions separated by time. Such an approach enables completing of the scorecard by a potential supplier to be a shared task that is shared amongst more than one employee of the supplier. The web-based scorecard 12 is suitably shared amongst employees of the potential supplier using the supplier identification number or other indexing mechanism to associate supplier-related information provided in the later session or sessions (possibly provided by different employees) with supplier-related information provided in the earlier session. In some embodiments, a given supplier may be provided with a different supplier identification number for each answering employee, with each identification number enabling editing of only those questions to be answered by the employee assigned that identification number. This enables limiting the editing by a given employee to only those questions which are to be answered by that employee.

Such approaches can also be used to enable the supplier to update the provided supplier-related information, for example to reflect additional manufacturing capacity added since initially filling out the scorecard. Moreover, it is to be appreciated that any given supplier may elect to not answer certain questions or portions of the web-based scorecard 12, although such unanswered questions or portions may weigh against selection of that supplier as a candidate supplier.

The selection of the one or more candidate suppliers 50 may complete the first stage of a two-stage process. At the end of the first stage, the retailer 16 has in its possession the list of candidate suppliers 50, such as between one and eight candidate suppliers, or more candidate suppliers. It has acquired this information at very low cost to the retailer 50 and to the suppliers (both chosen and not chosen).

With reference to FIGS. 5 and 6, two example embodiments of the second stage of such a two-stage process are described. In the second stage embodiment shown diagrammatically in FIG. 5, the retailer 16 employs a local agent 60 and one or more local inspectors 62 at the locale 64 of the supplier to perform on-site inspection or auditing of the facilities of the candidate supplier or suppliers 50. Because the number of candidate suppliers 50 is small (typically between one and eight), the number of local operatives 60, 62 can be small. Indeed, it is contemplated for a single local person to serve in both the local agent 60 and local inspector 62 capacities. The local agent 60 makes a recommendation 66 of one or more suppliers chosen from the list of candidate suppliers 50 based on the inspections. The retailer 16 then engages in contracting 68 with the recommended supplier or suppliers to establish a retail merchandise supply relationship with the recommended supplier or suppliers. FIG. 6 shows another embodiment of the second stage. In this embodiment, the retailer 16 elects to use its own inspector or auditor 62′, typically from outside of the locale 64, to perform the on-site inspections or auditing. This option is viable in some cases because the first stage has produced a sufficiently small list of candidate suppliers 50 that the outside inspector or auditor 62′ can perform adequate inspection of each candidate facility.

On the other hand, in some embodiments the selection of one or more candidate suppliers 50 based on the scorecard responses may end the search for suppliers. For example, if the veracity analyzer 52 provides a sufficiently reliable indication of candor by the responding suppliers, then the retailer 16 may feel confident in directly entering into contract negotiations with the supplier or suppliers selected based on the scorecard responses.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

The appended claims follow:

1. A method for identifying one or more retail merchandise suppliers, the method comprising:
generating a web-based scorecard configured to elicit supplier-related information of interest to a retailer;
constructing email content including at least (i) a business opportunity description, (ii) a URL address pointing to the web-based scorecard, and (iii) instructions to respond via the web-based scorecard in order to be considered for the business opportunity;
emailing the email content to at least thirty businesses;
receiving responses from at least some of the at least thirty businesses via the web-based scorecard, each said response including completing at least a portion of the web-based scorecard;
identifying between one and eight of said at least thirty businesses as candidate suppliers based on responses to the web-based scorecard; and
performing further contact between the retailer and suppliers limited to the identified candidate suppliers.

2. The method as set forth in claim 1, wherein the performing of further contact comprises:
performing on-site inspection or auditing of the identified candidate suppliers.

3. The method as set forth in claim 1, wherein the identifying comprises:
limiting the identifying to those of the at least thirty businesses from which responses were received; and
ranking those of the at least thirty businesses from which responses were received based on the corresponding responses to the web-based scorecard.

4. The method as set forth in claim 3, wherein the ranking comprises:
scoring each response based on score values assigned to answers to questions posed by the scorecard, the ranking being based on the scoring.

5. The method as set forth in claim 4, wherein the scoring comprises:
providing independent scores for different categories of responses.

6. The method as set forth in claim 1, wherein the identifying comprises:
determining a veracity measure for each of the at least thirty businesses from which responses were received based on the responses.

7. The method as set forth in claim 6, wherein the determining of the veracity measure comprises:
comparing different portions of the responses from a given business for internal consistency.

8. The method as set forth in claim 1, wherein the constructing comprises:
selecting a scorecard template; and
modifying the scorecard template to produce the web-based scorecard.

9. The method as set forth in claim 1, wherein the emailing comprises
emailing the email content to two or more persons within a single company, said responses being received from the two or more persons in different interactive web-based sessions with the web-based scorecard.

10. The method as set forth in claim 1, wherein the receiving of responses comprises:
receiving responses over time, the web-based scorecard enabling supplier-related information to be provided over multiple sessions separated in time.

11. An apparatus for identifying one or more retail merchandise suppliers, the apparatus comprising:
a web-based scorecard configured to acquire supplier-related information of interest to a retailer from potential suppliers;
a database communicating with the web-based scorecard to store the acquired supplier-related information sorted at least by responding supplier;
an emailer configured to send email content including at least:
a business opportunity description,
a URL address pointing to the web-based scorecard, and
instructions to respond via the web-based scorecard in order to be considered for the business opportunity,
to a plurality of potential suppliers; and
a processor communicating with the database and configured to select one or more of said plurality of potential suppliers based on the corresponding supplier-related information.

12. The apparatus as set forth in claim 11, wherein the processor assigns at least one score corresponding to each responding potential supplier based on the supplier-related information acquired from that responding potential supplier, the selecting being based at least in part on the assigned scores.

13. The apparatus as set forth in claim 12, wherein the scores assigned to each responding potential supplier by the processor include a plurality of independent scores corresponding to different categories of supplier-related information provided by that responding potential supplier.

14. The apparatus as set forth in claim 12, wherein the processor generates a ranked list of responding potential suppliers ranked by the at least one score.

15. The apparatus as set forth in claim 11, wherein the processor assigns a veracity measure to each responding potential supplier based at least on internal consistency of the supplier-related information acquired from that responding potential supplier.

16. The apparatus as set forth in claim 11, wherein the web-based scorecard is configured to acquire the supplier-related information from a responding potential supplier over two or more sessions separated in time.

17. The apparatus as set forth in claim 11, wherein the web-based scorecard is configured to acquire updated supplier-related information from a responding potential supplier, the updated supplier-related information being used to update the supplier-related information corresponding to that responding potential supplier in the database.

18. A computer-implemented method for identifying one or more retail merchandise suppliers, the computer-implemented method comprising:
constructing a website hosting a web-based scorecard configured to acquire supplier-related information of interest to a retailer from potential suppliers, the web-based scorecard including questions to be answered by potential suppliers and score assignments for said questions;
sending an email to a plurality of potential suppliers, the email having content including at least a business opportunity description, a URL address pointing to the web-based scorecard, identifying information that identifies the potential supplier to whom the email is sent, and instructions for the potential supplier to respond via the web-based scorecard in order to be considered for the business opportunity;
receiving responses from at least some of the potential suppliers via the website hosting the web-based scorecard, the responses including the identifying information that identifies the responding potential supplier and responses to the questions of the web-based scorecard provided by the responding potential supplier;
storing the responses and scores derived from said responses in a database communicating with the website hosting the web-based scorecard, the stored responses and scores being sorted at least by potential supplier based on the identifying information; and
processing the stored responses and scores to select at least one responding potential supplier as the retail merchandise supplier.

19. The computer-implemented method as set forth in claim 18, wherein the sending of emails to the plurality of potential suppliers comprises:
sending emails each including the identifying information as a query string appended to the URL address pointing to the web-based scorecard, whereby when the potential supplier to whom the email is sent accesses the URL address including the appended query string the identifying information is conveyed to the website hosting the web-based scorecard.

20. The computer-implemented method as set forth in claim 18, wherein the processing comprises:
performing one or more veracity analyses on the responses to the questions of the web-based scorecard provided by the potential supplier; and
assigning one or more veracity measures to the potential supplier based on the veracity analyses.

21. The computer-implemented method as set forth in claim 20, wherein the one or more veracity analyses comprise:
performing an internal consistency check comparing answers to different questions of the web-based scorecard to determine internal consistency of said answers indicative of candor of the responding potential supplier.

22. The computer-implemented method as set forth in claim 20, wherein the one or more veracity analyses comprise:
comparing answers to selected questions of the web-based scorecard with external information to determine candor of the responding potential supplier.
